(19) United States
(12) Patent Application Publication
(10) Pub. No.: US 2024/0237854 A1
(43) Pub. Date: Jul. 18, 2024

(54) CLEAR FOOD PROCESSOR WITH TOOLS

(71) Applicant: WHIRLPOOL CORPORATION, Benton Harbor, MI (US)

(72) Inventors: Samuel J. Bradley, St. Joseph, MI (US); Pravin R. Shewale, Pune (IN); Andrew John Leitert, Eus Claire, MI (US); Edward James Haney, St. Joseph, MI (US)

(73) Assignee: WHIRLPOOL CORPORATION, Benton Harbor, MI (US)

(21) Appl. No.: 18/096,086

(22) Filed: Jan. 12, 2023

(51) Int. Cl. A47J 43/046; A47J 43/07; B26D 1/147; B26D 7/26

(52) U.S. Cl. CPC A47J 43/046; A47J 43/0722; B26D 1/147; B26D 7/2614; B26D 2007/0018

(57) ABSTRACT

A food processor for a food item, the food processor comprises a base, a see-through receptacle configured to receive the food item. The receptacle is operably coupled with the base. The food processor also comprises a see-through lid operably coupled with the see-through receptacle. The food processor further comprises a drive shaft rotatably coupled with the base and a see-through tool support formed as a disc operably coupled with the drive shaft disposed within the see-through receptacle.

### BACKGROUND OF THE DISCLOSURE

The present disclosure generally relates to a food processor for separating food items into multiple parts and relates more particularly to a food processor including see-through components that provide a view of the food item, and even more in particular a transparent disc having a blade.

### SUMMARY OF THE DISCLOSURE

One aspect of the present disclosure is a food processor for a food item, the food processor comprising a base and a see-through receptacle configured to receive the food item. The receptacle may be operably coupled with the base. The food processor also comprises a see-through lid operably coupled with the see-through receptacle. The food processor further comprises a drive shaft rotatably coupled with the base and a slicer mounted on a see-through tool support operably coupled with the drive shaft disposed within the see-through receptacle.

Additional features of this aspect may include the see-through receptacle, see-through lid, drive shaft, and see-through tool support being made from a transparent material. The see-through tool support may be a disc having a blade. The see-through receptacle further includes a see-through lateral side and a see-through bottom surface. The see-through receptacle provides a lateral view of the food item and a top view of the food item. The see-through receptacle provides a bottom view of the food item when the receptacle is free of the base. The food processor further comprises a see-through handle coupled with the see-through receptacle. The see-through lid defines a lid opening that provides a path for the food item to enter the see-through receptacle. At least one of the see-through receptacle, see-through lid, drive shaft, and see-through tool support provide a top view of the path. The see-through tool support moves within the see-through receptacle when the food processor is in an operating mode.

Another aspect of the present disclosure is a food processor for a food item, the food processor comprising a motorized base and a drive shaft rotatably coupled with the motorized base. The food processor further comprises a receptacle operably coupled with the motorized base. The receptacle includes a transparent lateral side and an upper rim defining a first opening. The food processor also comprises a lid operably coupled with the upper rim. The lid has a transparent body. The food processor further comprises a bladed tool support operably coupled with the drive shaft, the bladed tool support moving within the receptacle. The bladed tool support may be transparent such that a user can view the food item from a lateral view and a top view.

Additional features of this aspect may include the body of the lid defining a lid opening for inserting the food item into the receptacle. The receptacle further includes a transparent bottom surface. A path for the food item is defined from the opening of the body of the lid to the transparent bottom surface of the receptacle. At least one of the lid, the receptacle, the drive shaft, and the bladed tool support provide a lateral view and a top view of the path. At least one of the lid, the receptacle, the drive shaft, and the bladed tool support provide a bottom view of the path when the receptacle is free of the motorized base.

Another aspect of the present disclosure is a food processor for a food item, the food processor comprising a motorized base and a receptacle operably coupled with the motorized base. The receptacle includes a transparent lateral side, a transparent bottom surface, and an upper rim that defines a first opening. The food processor further comprises a lid operably coupled with the upper rim of the receptacle. The lid has a transparent body. The food processor also comprises a drive shaft disposed within the receptacle and rotatably coupled with the motorized base. The food processor also comprises a transparent sleeve defining a cavity configured to receive the drive shaft. The food processor further comprises a transparent tool support operably coupled with the drive shaft. The transparent tool support is a disc upon which a blade may be mounted. The food item within the receptacle is viewable from a lateral view and from a top view when the receptacle is coupled with the motorized base. The food item within the receptacle may be viewable from a bottom view when the receptacle is free of the motorized base.

Additional features of this aspect may include at least one of the receptacle, the lid, the drive shaft, the transparent sleeve, and the transparent tool support that is a disc having a transparent tint. A transparent handle is coupled with the receptacle. A body of the transparent tool support that may be a disc is transparent. The transparent body of the lid defines a lid opening. A path for the food item is defined from the lid opening of the transparent body of the lid to the transparent bottom surface of the receptacle.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a lateral perspective view of a food processor having transparent elements;

FIG. 2A is a lateral perspective view of a food processor having transparent elements, a visible food item, and an opaque drive shaft;

FIG. 2B is a lateral perspective view of a food processor having transparent elements, a visible food item, and a transparent drive shaft;

FIG. 3A is a top perspective view of a food processor having transparent elements and an opaque blade;

FIG. 3B is a top perspective view of a food processor having transparent elements and a transparent blade;

FIG. 4A is a top perspective view of a food processor having transparent elements and a transparent blade providing a top view of a food item;

FIG. 4B is a top perspective view of a food processor having transparent elements and a transparent blade in a spinning mode providing a top view of a food item;

FIG. 5 is an exploded view of a food processor having transparent elements.

The components in the figures are not necessarily to scale, emphasis instead being placed upon illustrating the principles described herein.

### DETAILED DESCRIPTION

The present illustrated embodiments reside primarily in combinations of apparatus elements or components related to a see-through food processor with a tool support. Accordingly, the apparatus components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

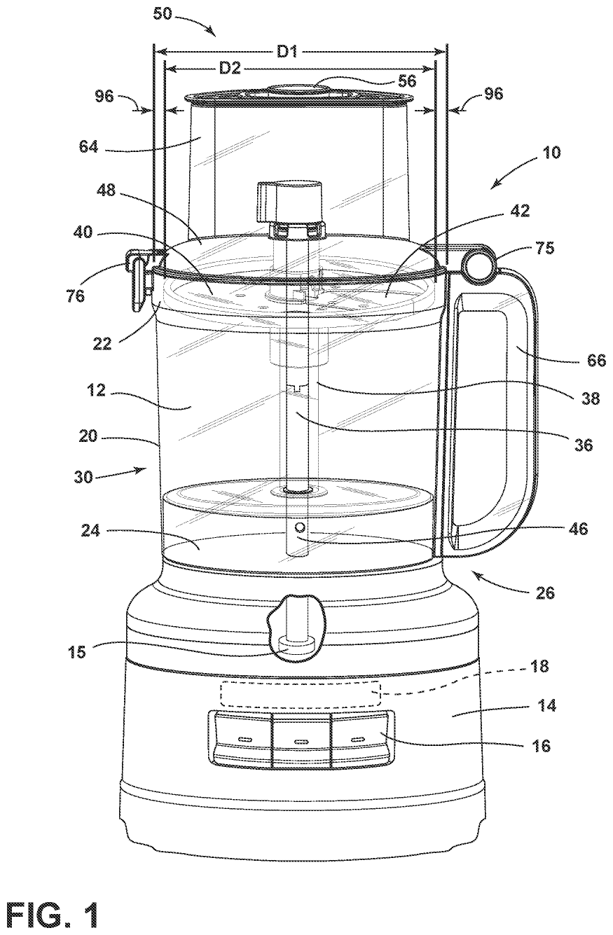

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

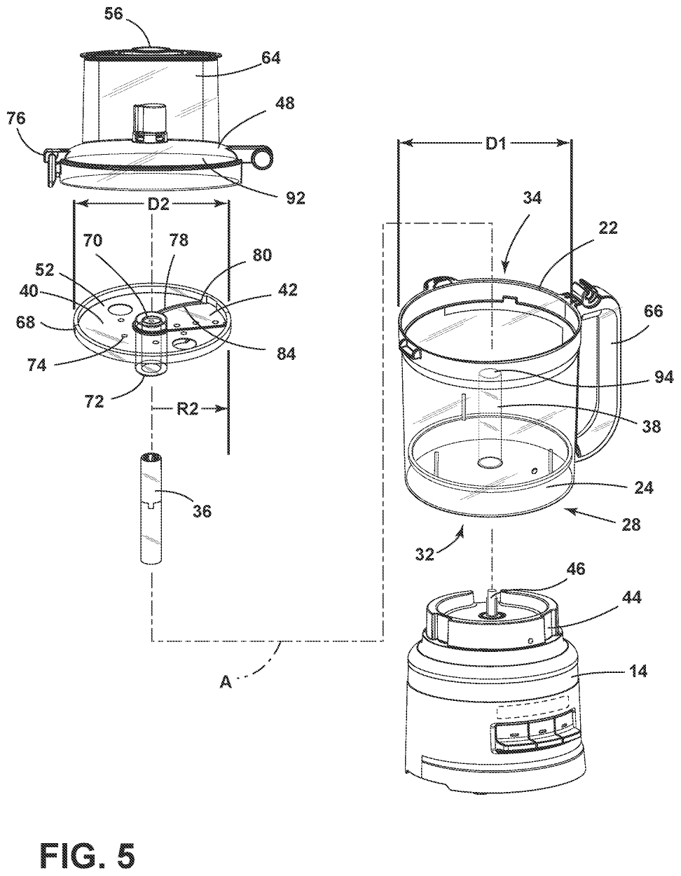

With reference to FIGS. 1-3B, a food processor 10 includes a base 14 and a receptacle 12. The base 14 may include a motor 15 such that the base 14 is a motorized base. The base 14 may include an actuator 16 communicatively coupled with a controller 18. The controller 18 may be configured to operate the motor. The receptacle 12 operably couples with the base 14. The receptacle 12 is see-through and transparent, such that the receptacle 12 provides a view of a food item disposed within the receptacle 12 through a solid, continuous portion of a material of which the receptacle 12 is made. The receptacle 12 includes a lateral side 20, an upper rim 22, and a bottom surface 24. The lateral side 20 and the bottom surface 24 are each see-through and transparent. The receptacle 12 transitions between an operable position 26 when the base 14 operably couples with the base 14 and a free position 28 when the receptacle 12 is free of the base 14. The lateral side 20 provides a lateral view 30 of the food item within the receptacle 12 whether the receptacle 12 is in the operable position 26 or the free position 28. The bottom surface 24 provides a bottom view 32 of the food item within the receptacle 12 when the receptacle 12 is in the free position 28. The upper rim 22 of the receptacle 12 defines a first opening 34, best shown in FIG. 5.

The receptacle 12 is configured to receive a drive shaft 36, a drive shaft sleeve 38, a tool support 40, upon which a blade 42 is mounted, and the processed food item through the first opening 34. The receptacle 12 is also configured to remove the food item, the drive shaft 36, the drive shaft sleeve 38, and the tool support 40 having the blade 42 through the first opening 34. The receptacle 12 may couple with the base 14 at the bottom surface 24 of the receptacle 12. At least one of the base 14 and the bottom surface 24 of the receptacle 12 may include a locking mechanism 44 (e.g., threaded portions, groove and protrusions, or tracks) to operably couple the receptacle 12 with the base 14. The motor 15 is coupled with a rotary shaft 46 that outwardly extends from the base 14 and protrudes into the receptacle 12 in the operable position 26. The receptacle 12 may be generally circular, generally prismatic, or of a similar three-dimensional geometry.

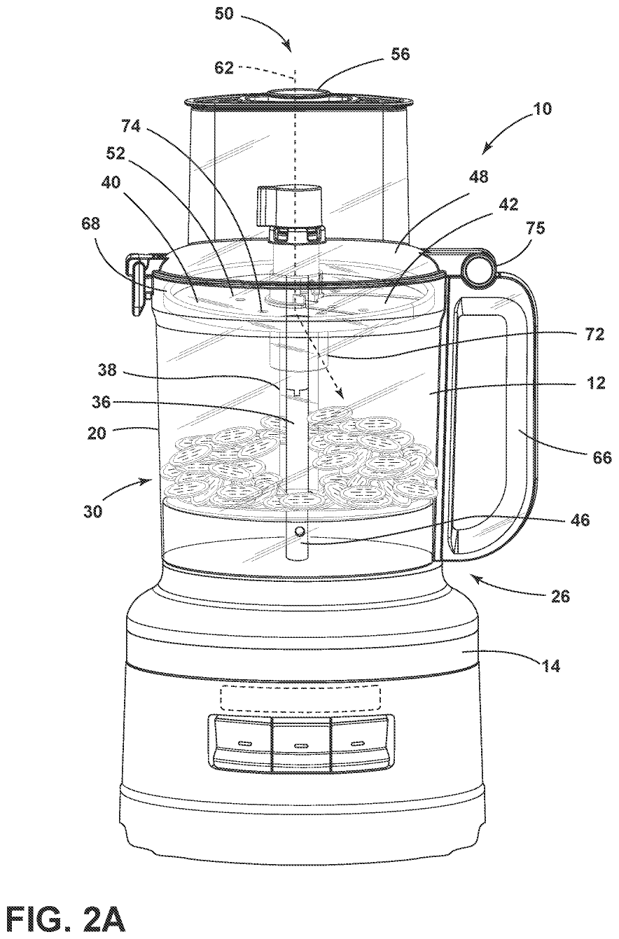

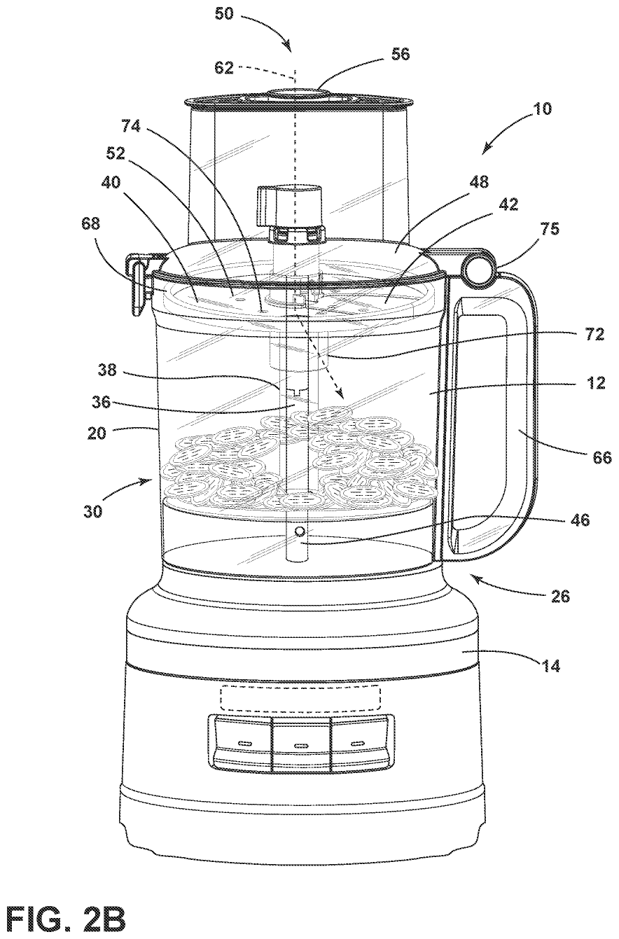

With further reference to FIGS. 1-2B, a lid 48 operably couples with the upper rim 22 of the receptacle 12. The lid 48 may be pivotally coupled with the upper rim 22 of the receptacle 12. The lid 48 is see-through and transparent. The lid 48 provides a top view 50 of the food item disposed within the receptacle 12.

The drive shaft 36 couples with the rotary shaft 46. The drive shaft 36 may be configured to receive the rotary shaft 46. As shown in FIG. 5, the drive shaft 36 may be configured to rotate about a rotational axis A that is the same as the rotary shaft 46. The drive shaft 36 may be see-through and transparent. The drive shaft 36 operably couples with the tool support 40 having the blade 42 and may extend vertically within the drive shaft sleeve 38. The drive shaft sleeve 38 may be see-through and transparent and the tool support 40 having a blade 42 is see-through and transparent on most of a disc body 52 of the tool support 40. The blade 42 of the tool support 40 may be see-through and transparent (e.g., a high-density polymeric material, an acrylic, a transparent metal such as aluminum oxynitride, or another transparent ceramic or polymeric material). The blade 42 of the tool support 40 may be opaque (e.g., an opaque metal such a stainless steel) such that a solid, continuous portion of the blade 42 between a viewer and the food item does not provide a view through the solid, continuous portion of the blade 42 that is opaque. The drive shaft 36 may be opaque such that a solid, continuous portion of the drive shaft 36 between a viewer and the food item does not provide a view through the solid, continuous portion of the drive shaft 36 that is opaque. The lid 48 defines a lid opening 56.

At least one of the drive shaft 36, the drive shaft sleeve 38, the tool support 40, the blade 42, and the lid 48 provide the top view 50 of the food item disposed within the receptacle 12 in the operable position 26 and the free position 28. The rotary shaft 46 coupled with the motor 15 is operable between two modes: a spinning mode and a halted mode. The drive shaft 36 spins when the rotary shaft 46 is in the spinning mode. The drive shaft 36 halts when the rotary shaft 46 is in the halted mode. The tool support 40 spins when the rotary shaft 46 is in the spinning mode, and the tool support 40 halts when the rotary shaft 46 is in the halted mode. The tool support 40 provides the top view 50 of the food item disposed within the receptacle 12 when the rotary shaft 46 is in the spinning mode and the halted mode.

The lid opening 56 of the lid 48 is configured to receive the food the food item. The path 62 of the food item is defined between the lid opening 56 to the bottom surface 24 of the receptacle 12. At least one of the lid 48, the tool support 40, the blade 42, the drive shaft sleeve 38, the drive shaft 36, and the lateral side 20 provide a lateral view 30. At least one of the bottom surface 24, the tool support 40, the blade 42, the drive shaft sleeve 38, the drive shaft 36, and the lateral side 20 provide a bottom view 32 of the food item. At least one of the receptacle 12, the lid 48, the drive shaft 36, the drive shaft sleeve 38, the tool support 40, and the blade 42 may have a transparent tint. The lid 48 may also include an insertion chamber 64. The lid opening 56 may be disposed directly on the lid 48 or on the insertion chamber 64. The insertion chamber 64 may be see-through and transparent.

A handle 66 may be coupled with the receptacle 12. The handle 66 may be see-through and transparent. The receptacle 12 has a maximum inner diameter D1. The tool support 40 is a disc. The tool support has a diameter D2, such that D2 is less than D1. D2 may be large enough that the top view 50 of the food item disposed within the receptacle 12 includes looking through the solid, continuous portion of the tool support 40. The tool support 40 may include a lip 68. The tool support 40 defines an aperture 70. The aperture 70 is configured to receive the drive shaft 36. The tool support 40 may include a tube 72. The tube 72 may define the aperture 70. The tube 72 is configured to receive the drive shaft 36 and the drive shaft sleeve 38. The tool support 40 may include cleaning apertures 74. At least one of the receptacle 12, the bottom surface 24, the lateral side 20, the lid 48, the tool support 40, and the blade 42 provide the top view 50 of the base 14 in the operable position 26. The tool support 40 may be transparent such that it provides the lateral view 30, the bottom view 32, and the top view 50 of an inside of the aperture 70 and the cleaning apertures 74. The aperture 70 may be a central aperture. The aperture 70 and tube 72 of the tool support 40 provide the lateral view 30, the bottom view 32, and the top view 50 of the drive shaft 36 inserted in the central aperture 70 of the tool support 40. The lateral side 20 of the receptacle 12 may include a latch 76 that locks the lid 48 with the lateral side 20 opposite of where the lid 48 and the lateral side 20 are pivotally coupled at a detachable hinge 75. The lip 68 of the tool support 40 may be see-through and transparent such that a residual food item of the food item is visible from the lateral view 30, the bottom view 32, and the top view 50 of the tool support 40.

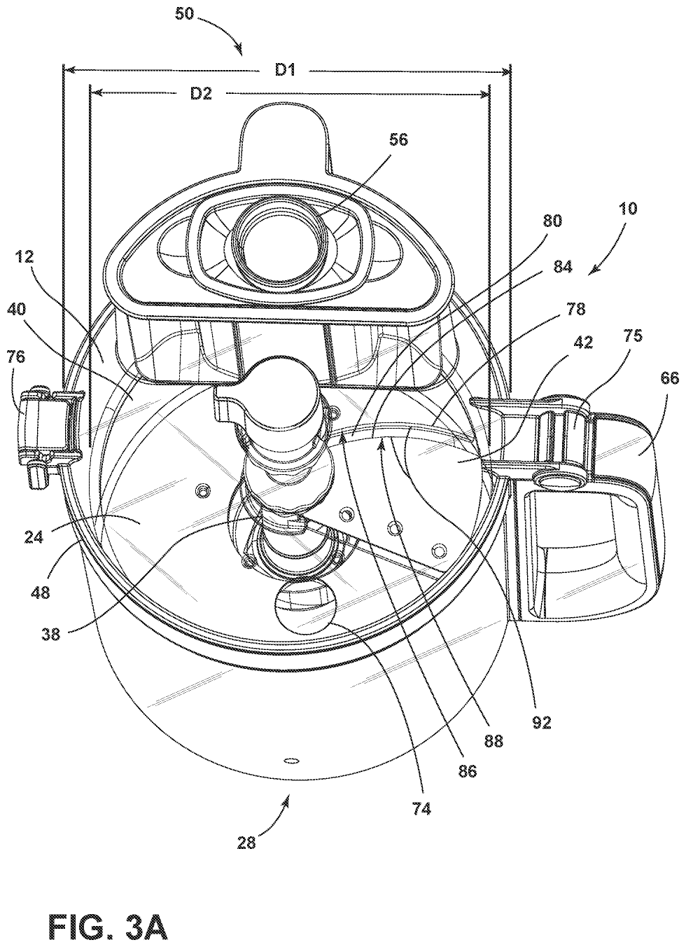

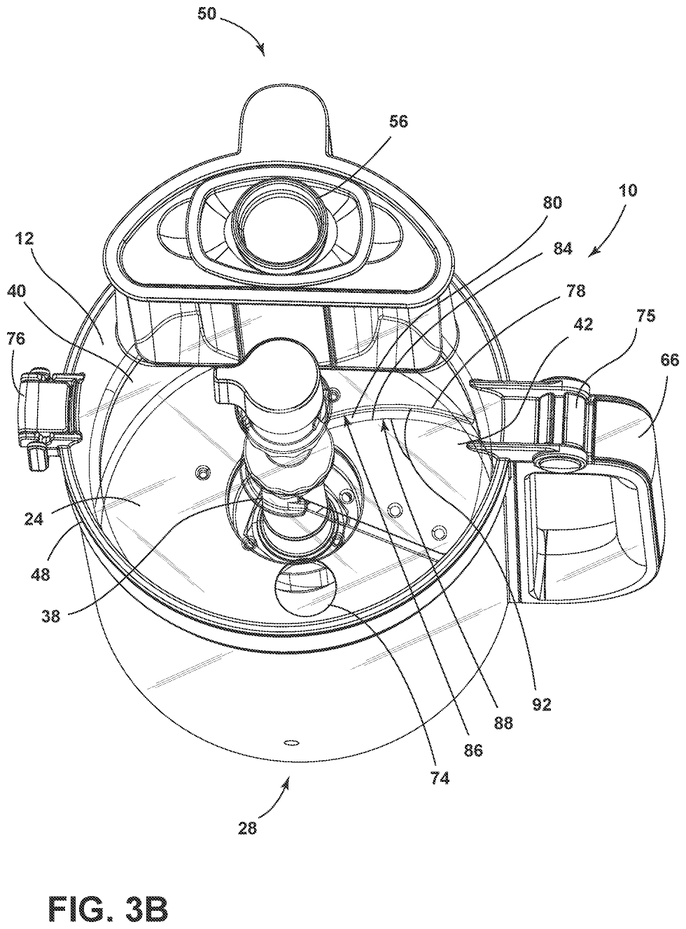

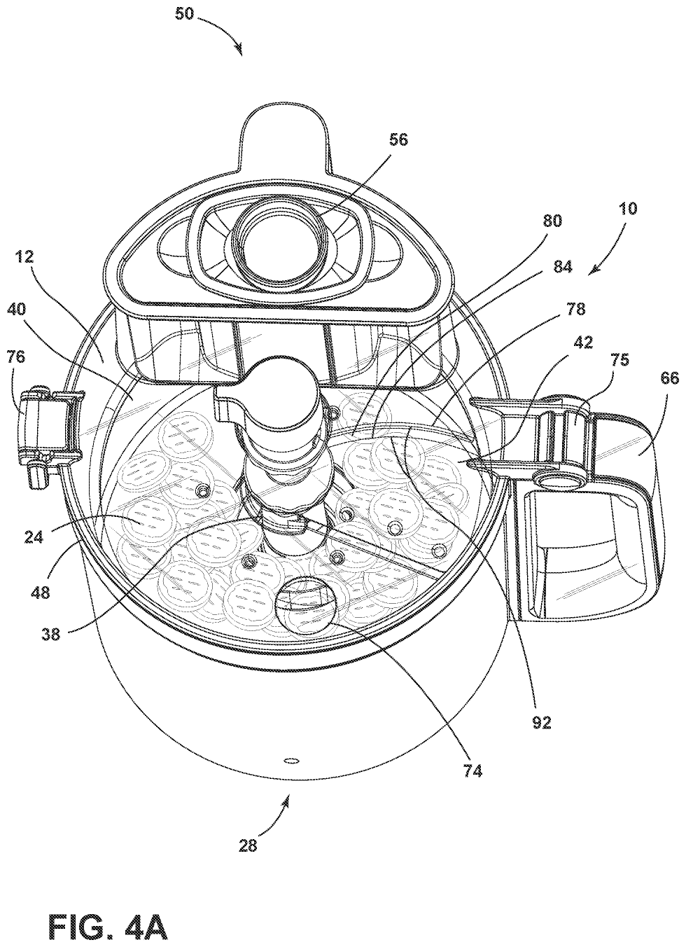

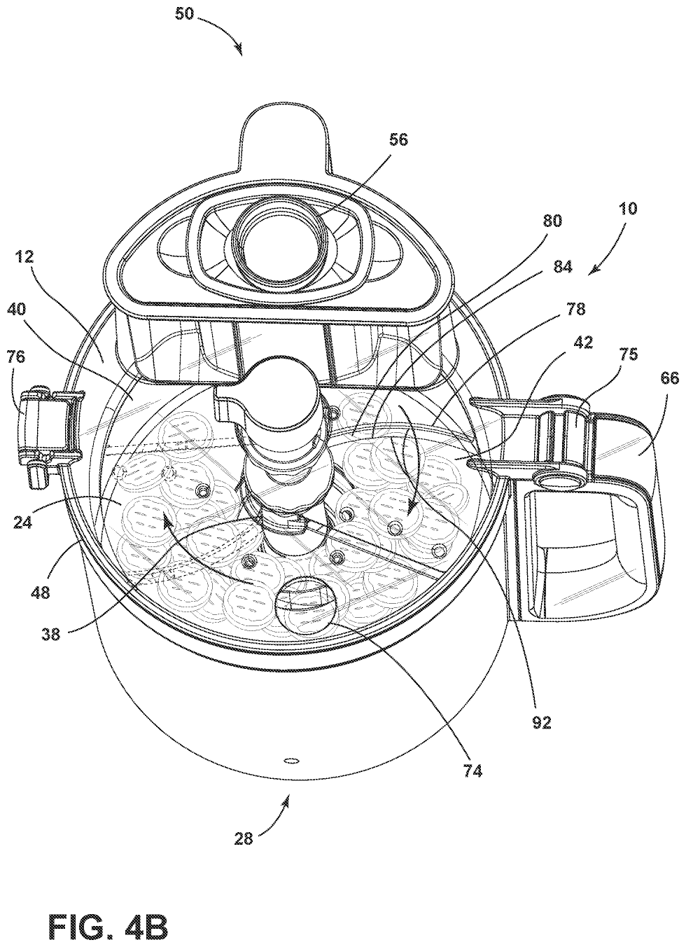

With reference to FIGS. 3A-4B, the tool support 40, which may be a disc, includes the disc body 52. The disc body 52 includes a radial edge 78. The radial edge 78 partially defines a slit 80. The radial edge 78 extends between the aperture 70 that is centered in the tool support 40 and the lip 68 of the tool support 40. The lip 68 is unitarily coupled with an outer circumference 82 of the tool support 40. The radial edge 78 may extend radially from the tube 72 to the lip 68.

As seen in FIGS. 1, 3A-4B, and 5 a radius R2, of the tool support 40 is equal to half the diameter of the tool support, D2. The radial edge 78 extends a distance, as opposed to length, that is less than R2. The total length of the radial edge 78 may be greater than, equal to, or less than R2. The blade 42 of the tool support 40 may be coupled with the disc body 52, insert molded into the disc body 52, or unitarily formed with the disc body 52. The blade 42 includes a blade edge 84. The blade edge 84 and the radial edge 78 define the slit 80. The blade edge 84 and the radial edge 78 may include a first profile 86 and second profile 88, respectively. The first profile 86 and the second profile 88 may be complementary (e.g., the first profile 86 is a convex curve and the second profile 88 is a concave curve). In the spinning mode, the food item that follows the path 62 contacts the blade edge 84 and is divided into at least two smaller food items from the food item. In this respect, the tool support 40 having the blade 42 may be a slicer. At least one of the two smaller food items fall through the slit 80 to continue along the path 62 toward the bottom surface 24 of the receptacle 12. The diameter D2 of the tool support 40 measured through the slit 80 includes dimensions of the lip 68, the tube 72, the aperture 70, the slit 80, and the disc body 52, and may also include dimensions of the blade 42, the blade edge 84, and the radial edge 78. The blade edge 84 and the radial edge 78 may be curved such that the path 62 of the food item is directed toward an apex 90 of each of the curved radial edge 78 and the curved blade edge 84.

With references to FIGS. 1-4B, the lip 68, the disc body 52, the radial edge 78, the tube 72, and possibly the blade 42 and the blade edge 84 provide a view of a space 96 between the lip 68 and the lateral side 20 of the receptacle 12. Any of the food item that deviates from the path 62 and ends up between the lip 68 and the lateral side 20 is seen from the lateral view 30 provided by the lip 68, the disc body 52, the radial edge 78, the tube 72, and possibly the blade 42 and blade edge 84. Any of the food item that deviates from the path 62 and ends up between the tube 72 and the drive shaft 36 is seen from the lateral view 30 provided by the lip 68, the disc body 52, the radial edge 78, the tube 72, and possibly the blade 42 and blade edge 84. Thus, any food item that deviates from the path 62 may be readily identified and retrieved by a user.

With further reference to FIGS. 1-5, a food processor 10 for a food item, the food processor 10 comprises a base 14, a see-through receptacle 12 configured to receive the food item. The receptacle 12 is operably coupled with the base 14. The food processor 10 also comprises a see-through lid 48 operably coupled with the see-through receptacle 12. The food processor 10 further comprises a drive shaft 36 rotatably coupled with the base 14 and a see-through tool support 40 that may be a slicer operably coupled with the drive shaft 36 disposed within the see-through receptacle 12. The see-through receptacle 12, see-through lid 48, drive shaft 36, and see-through tool support 40 that may be a slicer are made from a transparent material. The see-through tool support 40 that may be a slicer is also a disc having a blade 42. The see-through receptacle 12 further includes a see-through lateral side 20 and a see-through bottom surface 24. The see-through receptacle 12 provides a lateral view 30 of the food item and a top view 50 of the food item. The see-through receptacle 12 provides a bottom view 32 of the food item when the receptacle 12 is free of the base 14. The food processor 10 further comprises a see-through handle 66 coupled with the see-through receptacle 12. The see-through lid 48 defines a lid opening 56 that provides a path 62 for the food item to enter the see-through receptacle 12. At least one of the see-through receptacle 12, see-through lid 48, drive shaft 36, and see-through tool support 40, shown in the Figures as a slicer, provide a top view 50 of the path 62. The see-through tool support 40 that may be a slicer moves within the see-through receptacle 12 when the food processor 10 is in a spinning mode.

With further reference to FIGS. 1-5, a food processor 10 is for a food item, the food processor comprises a motorized base 14 and a drive shaft 36 rotatably coupled with the motorized base 14. The food processor 10 further comprises a receptacle 12 operably coupled with the motorized base 14. The receptacle 12 includes a transparent lateral side 20 and an upper rim 22 defining a first opening 34. The food processor 10 also comprises a lid 48 operably coupled with the upper rim 22. The lid has a transparent body 92. The food processor 10 further comprises a bladed tool support 40 operably coupled with the drive shaft 36, the bladed tool support 40 moving within the receptacle 12. The bladed tool support 40 is transparent such that a user can view the food item from a lateral view 30 and a top view 50. The body 92 of the lid 48 defines a lid opening 56 for inserting the food item into the receptacle 12. The receptacle 12 further includes a transparent bottom surface 24. A path 62 for the food item may be defined from the opening 56 of the body 92 of the lid 48 to the transparent bottom surface 24 of the receptacle 12. At least one of the lid 48, the receptacle 12, the drive shaft 36, and the bladed tool support 40 provide the lateral view 30 and the top view 50 of the path 62. At least one of the lid 48, the receptacle 12, the drive shaft 36, and the bladed tool support 40 provide a bottom view 32 of the path 62 when the receptacle 12 is free of the motorized base 14.

With further reference to FIGS. 1-5, a food processor 10 for a food item, the food processor 10 comprises a motorized base 14 and a receptacle 12 operably coupled with the motorized base 14. The receptacle 12 includes a transparent lateral side 20, a transparent bottom surface 24, and an upper rim 22 that defines a first opening 34. The food processor 10 further comprises a lid 48 operably coupled with the upper rim 22 of the receptacle 12. The lid 48 has a transparent body 92. The food processor 10 also comprises a drive shaft 36 disposed within the receptacle 12 and rotatably coupled with the motorized base 14. The food processor 10 also comprises a transparent sleeve drive shaft sleeve 38 defining a cavity 94 configured to receive the drive shaft 36. The food processor 10 further comprises a transparent tool support 40 operably coupled with the drive shaft 36. The transparent tool support 40 may be a disc upon which a blade 42 may be mounted. The food item within the receptacle 12 is viewable from a lateral view 30 and from a top view 50 when the receptacle 12 is coupled with the motorized base 14. The food item within the receptacle 12 is viewable from a bottom view 32 when the receptacle 12 is free of the motorized base 14. At least one of the receptacle 12, the lid 48, the drive shaft 36, the transparent sleeve 38, and the transparent tool support 40 that may be a disc have a transparent tint. A transparent handle 66 may be coupled with the receptacle 12. A disc body 52 of the transparent tool support 40 that is a disc may be transparent. The transparent body 92 of the lid 48 defines a lid opening 56. A path 62 for the food item may be defined from the lid opening 56 of the transparent body 92 of the lid 48 to the transparent bottom surface 24 of the receptacle 12.

It will be understood by one having ordinary skill in the art that construction of the described disclosure and other components is not limited to any specific material. Other exemplary embodiments of the disclosure disclosed herein may be formed from a wide variety of materials, unless described otherwise herein. For example, while a tool support 40 adapted for slicing is disclosed herein, the food processor 10 may also be provided with a tool support 40 adapted for grating, dicing, or shredding.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A food processor for a food item, the food processor comprising:
a motorized base;
a see-through receptacle configured to receive the food item, the receptacle operably coupled with the motorized base;
a see-through lid operably coupled with the see-through receptacle;
a drive shaft rotatably coupled with the motorized base; and
a see-through tool support operably coupled with the drive shaft disposed within the see-through receptacle.

2. The food processor of claim 1, wherein the see-through receptacle, see-through lid, drive shaft, and see-through tool support are made from a transparent material.

3. The food processor of claim 1, wherein the see-through tool support further comprises a slicing disc having a blade.

4. The food processor of claim 1, the see-through receptacle further including:
a see-through lateral side; and
a see-through bottom surface, wherein the see-through receptacle provides a lateral view of the food item and a top view of the food item.

5. The food processor of claim 4, wherein the see-through receptacle provides a bottom view of the food item when the receptacle is free of the motorized base.

6. The food processor of claim 1, further comprising:
a see-through handle coupled with the see-through receptacle.

7. The food processor of claim 1, wherein the see-through lid defines a lid opening that provides a path for the food item to enter the see-through receptacle.

8. The food processor of claim 7, wherein at least one of the see-through receptacle, see-through lid, drive shaft, and see-through tool support provide a top view of the path.

9. The food processor of claim 1, wherein the see-through tool support moves within the see-through receptacle when the food processor is in an operating mode.

10. A food processor for a food item, the food processor comprising:
a motorized base;
a drive shaft rotatably coupled with the motorized base;
a receptacle operably coupled with the motorized base, the receptacle including:
a transparent lateral side; and
an upper rim defining a first opening;
a lid operably coupled with the upper rim, the lid having a transparent body; and
a bladed tool support operably coupled with the drive shaft, the bladed tool support moving within the receptacle, and the bladed tool support further comprising a disc that is transparent such that a user can view the food item from a lateral view and a top view.

11. The food processor of claim 10, wherein a body of the lid defines a lid opening for inserting the food item into the receptacle.

12. The food processor of claim 11, the receptacle further including a transparent bottom surface.

13. The food processor of claim 12, wherein a path for the food item is defined from the opening of the body of the lid to the transparent bottom surface of the receptacle.

14. The food processor of claim 13, wherein at least one of the lid, the receptacle, the drive shaft, and the bladed tool support provide the lateral view and the top view of the path.

15. The food processor of claim 14, wherein at least one of the lid, the receptacle, the drive shaft, and the bladed tool support provide a bottom view of the path when the receptacle is free of the motorized base.

16. A food processor for a food item, the food processor comprising:
a motorized base;
a receptacle operably coupled with the motorized base, the receptacle including:
a transparent lateral side;
a transparent bottom surface; and
an upper rim that defines a first opening;
a lid operably coupled with the upper rim of the receptacle, the lid having a transparent body;
a drive shaft disposed within the receptacle and rotatably coupled with the motorized base;
a transparent sleeve defining a cavity configured to receive the drive shaft; and
a transparent disc operably coupled with the drive shaft, the transparent disc having a blade, wherein the food item within the receptacle is viewable from a lateral view and a top view when the receptacle is coupled with the motorized base, and further wherein the food item within the receptacle is viewable from a bottom view when the receptacle is free of the motorized base.

17. The food processor of claim 16, wherein at least one of the receptacle, lid, drive shaft, transparent sleeve, and transparent disc have a transparent tint.

18. The food processor of claim 16, wherein a transparent handle is coupled with the receptacle.

19. The food processor of claim 16, wherein a disc body of the transparent disc is transparent.

20. The food processor of claim 16, wherein the transparent body of the lid defines a lid opening, wherein a path for the food item is defined from the lid opening of the transparent body of the lid to the transparent bottom surface of the receptacle.
